(19) United States
(12) Patent Application Publication
(10) Pub. No.: US 2020/0267910 A1
(43) Pub. Date: Aug. 27, 2020

(54) Adaptive Growing Modules

(71) Applicant: Larry Wilson, Forest Ranch, CA (US)

(72) Inventor: Larry Wilson, Forest Ranch, CA (US)

(21) Appl. No.: 16/798,274

(22) Filed: Feb. 21, 2020

Related U.S. Application Data
(60) Provisional application No. 62/808,773, filed on Feb. 21, 2019.

(51) Int. Cl. A01G 9/02; A01G 9/24

(52) U.S. Cl. CPC A01G 9/027; A01G 9/023; A01G 9/247

(57) ABSTRACT

A prefabricated modular grow box featuring: an irrigation system, a drainage system, stands, stacking support, structural support, and built-in greenhouse roof supports; all designed for maximum efficiency in storage and deployment.

### CROSS REFERENCE TO RELATED APPLICATIONS

This application claims the benefit of U.S. Provisional Patent Application No. 62/808,773, filed on Feb. 21, 2019, and also titled “Adaptive Growing Modules” which is incorporated by reference herein in its entirety for all purposes.

### BACKGROUND OF THE INVENTION

### 1. Field of the Invention

The present invention is in the technical field of grow boxes. More particularly, the present invention pertains to the field of stackable modular grow boxes with drainage.

### 2. Description of Related Art

Container gardening has been around since prehistoric times; grow boxes are containers that are partially or completely enclosed systems for raising plants indoors or in small areas. Grow boxes are used for a number of reasons, including lack of available outdoor space or the desire to grow vegetables, herbs, or flowers during cold weather months. They can also help protect plants against pests or disease. Grow boxes are typically soil-based or hydroponic. The most sophisticated examples are totally enclosed; and contain a built-in grow light; intake and exhaust fan systems for ventilation; hydroponic systems that waters the plants with nutrient-rich solution; and, if necessary, an odor control filter. Some advanced grow box units even include air conditioning to keep running temperatures down, as well as CO2 to boost plant growth rates.

Modern grow boxes have a vast assortment of high technology solutions for growing plants, but their basic designs require retrofitting common boxes with: irrigation systems, drainage systems, stands, stacking support, structural support, and built-in greenhouse roof supports. The present invention solves these basic design flaws.

### SUMMARY

The scope of the present invention is defined solely by the appended claims and detailed description of a preferred embodiment and is not affected to any degree by the statements within this summary. In addressing many of the problems experienced in the related art, the present disclosure generally involves a prefabricated modular grow box featuring the following built-in functionality: an irrigation system, a drainage system, stands, stacking support, structural support, and built-in greenhouse roof supports.

### BRIEF DESCRIPTION OF THE DRAWINGS

Various embodiments are described herein with reference to the following Drawings Certain aspects of the Drawings are depicted in a simplified way for reason of clarity. Not all alternatives and options are shown in the Drawings and, therefore, the Claims are not limited in scope to the content of the Drawings.

### 1. FIGURES

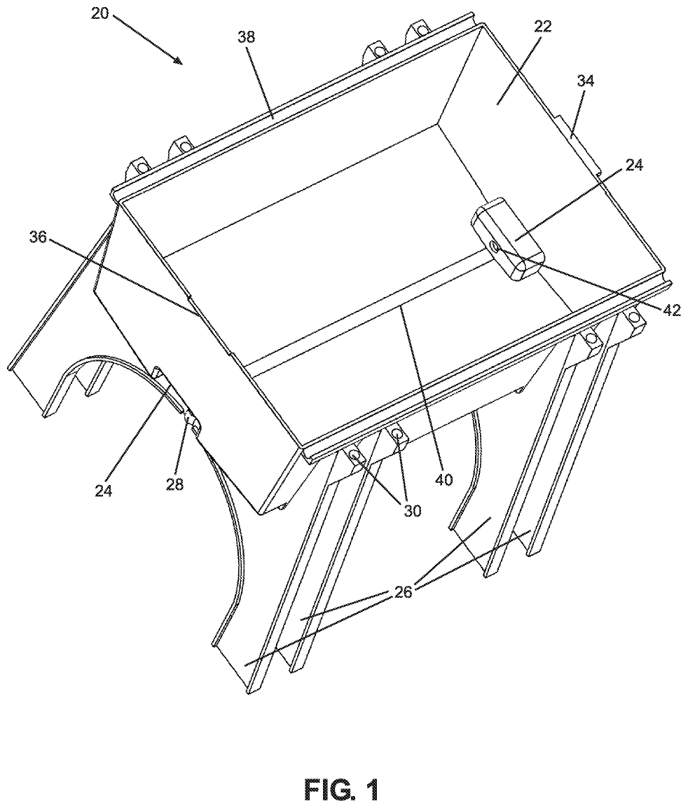

FIG. 1 illustrates a top perspective view of a modular grow box, in accordance with an embodiment of the present disclosure.

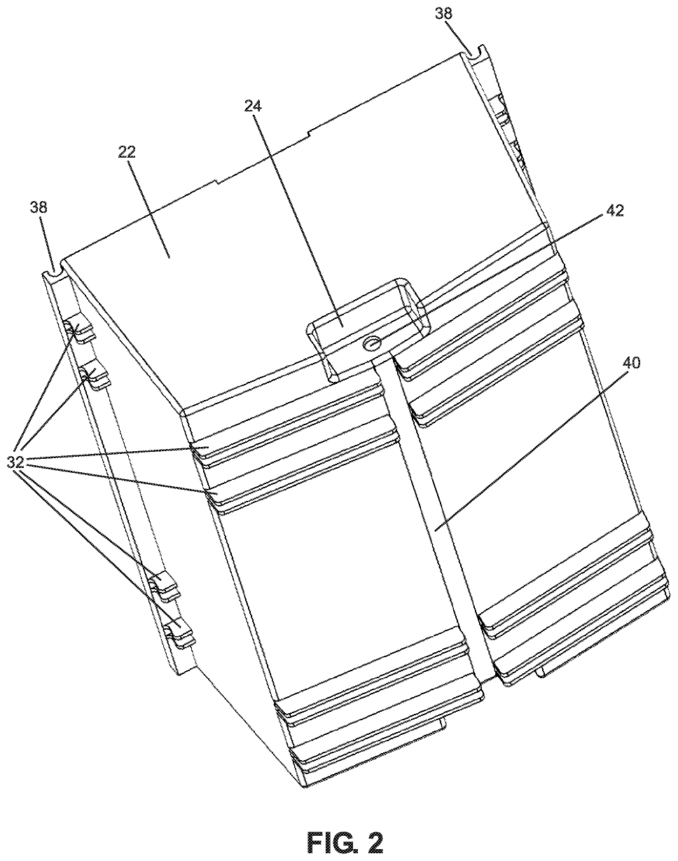

FIG. 2 illustrates a bottom perspective view of a modular grow box, in accordance with an embodiment of the present disclosure.

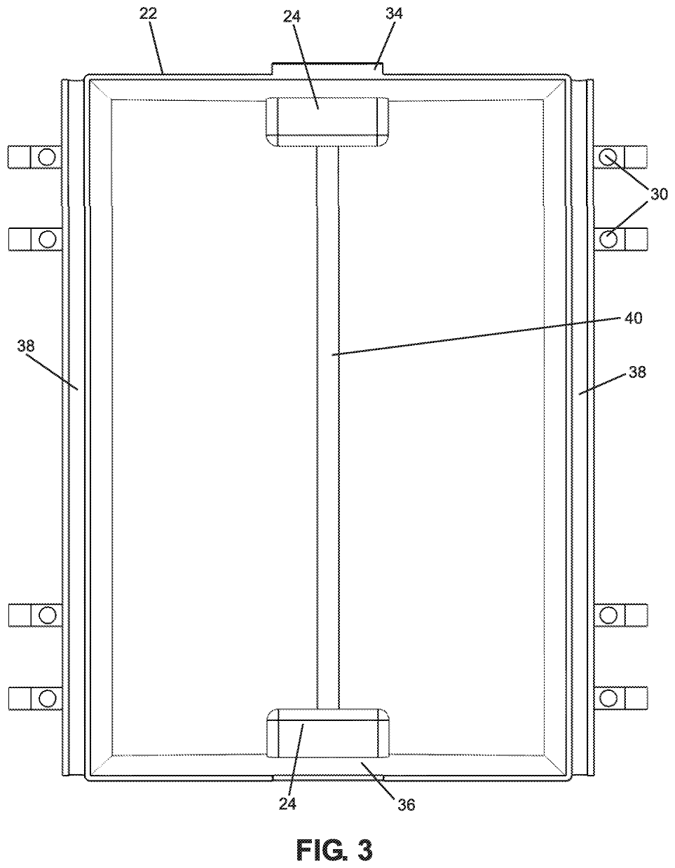

FIG. 3 illustrates a top view of a modular grow box, in accordance with an embodiment of the present disclosure.

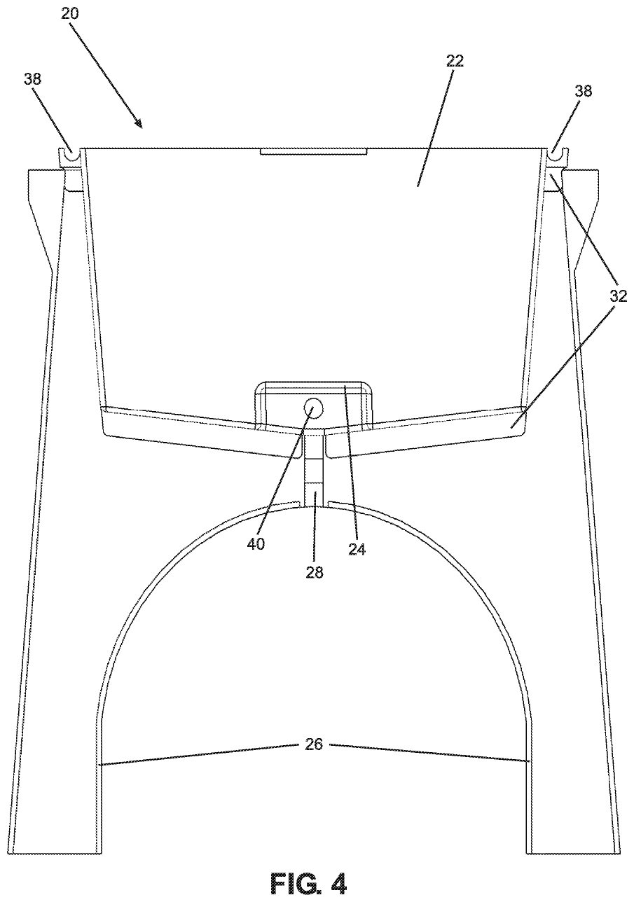

FIG. 4 illustrates a side view of a modular grow box, in accordance with an embodiment of the present disclosure.

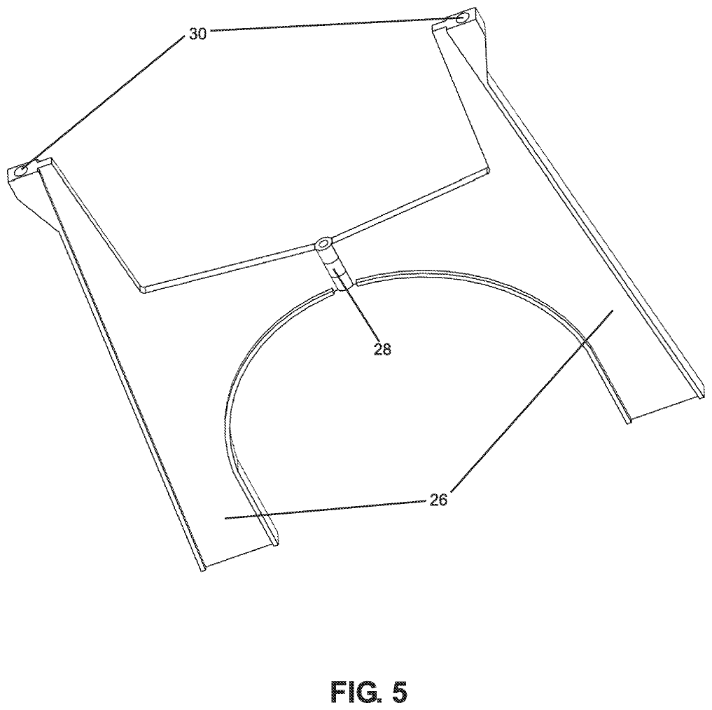

FIG. 5 illustrates a top perspective view of a modular grow box support, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### 2. REFERENCES

20 Adaptive Growing Modules
22 Box
24 Handle
26 Leg
28 Hinge
30 Points of attachment on the legs
32 Point of Attachment on the box
34 Box-to-box Coupling Attachment
36 Box-to-box Receiving Coupling Attachment
38 Irrigation Hose Channel
40 Bottom Side Water Irrigation Channel
42 Drainage Hole

### DETAILED DESCRIPTION

The following description is not to be taken in a limiting sense; but, is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same. Generally, this patent describes adaptive growing modules (20). As seen in FIG. 1, adaptive growing modules (20) comprise one or more boxes (22). The boxes have five sides: a bottom, front, back, left, and right; and optionally also a top—although a top would likely be a separate piece that is transparent to light. The boxes (22) themselves can be made out of one or more of any material suitable for their purpose, such as: plastic, rubber, metal, wood, etc; but are preferred to be made out of food grade materials so as not to contaminate any consumables grown in the boxes. The boxes may be sized to be about the width of an adult's outstretched arms while they carry the box, which may be between 28 inches and 40 inches long; but, may preferably be around 34 inches long. The box may be made with a height that allows for an adult to comfortably lift the box from the handles without the box pressing into the user's upper arms; that height may be between 7 inches and 14 inches tall; but, is preferably around 11 inches tall. The box may also be made with a width that allows for the user to carry the box without the center of balance being too far forward from the user, risking the box falling over. The width of the box may be between 19 inches and 25 inches wide; but, is preferably around 22 inches wide. The boxes may also comprise handles (24), which may be located on their bottoms for easy grasping and carrying the box while it is loaded with materials. The handles (24) may be recesses along the sides of the bottom of the box.

The box (22) is built with sides that slant outward from the bottom of the box to the top; this allows the box (22) to be nested one inside the other to occupy minimal space during shipping and storage.

As seen in FIGS. 1, 4 and 5, the adaptive growing modules (20) may also comprise legs (26). The legs (26) may be made out of the same materials as the box (22) may be made out of. The individual legs (26) may be attached together and may have hinges (28) in their middle allowing them to attach and be folded and placed conveniently in the box (22). As seen in FIGS. 1, 3, and 5 the legs (26) may also points of attachment (30), which may be holes on their tops and/or bottoms for attaching all manner of things, such as lids and poles, or additional adaptive growing modules. The legs (26) may also have a curved downward portion which is well suited to securely fit a half cylindrical cover (not pictured) for the box to keep heat and moisture in and bugs and cold out. The legs hold the box up making care and weeding convenient.

As seen in FIGS. 2 and 4 there may be one or more points of attachment (32) for the legs (26), in this embodiment the points of attachment (32) are slots built out of the box (22) that the legs (26) can fit into. In this embodiment, the two middle slots are the main positions for the legs. The end slots are intended to be placed on the end position of the last module in the row. This allows for the greenhouse to fit flush to the end of the garden.

As seen in FIG. 1, the adaptive growing modules may be connect to each other lengthwise by a box-to-box coupling attachment (34) that attaches to a receiving coupling attachment on the opposite side of similar box (36); this allows the boxes to be easy linked closely together with precise spacing. The box-to-box coupling attachment may be a bulkhead fitting situated at the distal ends of a box. Optionally, a small piece of poly tubing may be fitted over the ends of the bulkhead fittings. In this manner the boxes may be joined together end-to-end in order to create long rows of growing modules. They can also be placed side by side to aid in harvesting. The modules can be arranged in almost any configuration, and can be placed on concrete, blacktop, balconies, rooftops, basements, abandoned buildings, parks or commercial greenhouses. The boxes can also be stacked one on top of the other.

The boxes may also be connected to each other by irrigation tubing. The irrigation tubing may be attached to an irrigation channel (38); as seen in FIGS. 1, 2, 3, and 4; built into the side of the boxes (22). There may be two irrigation hose channels (38) that allow the choice of placing the tubing in the front (for ease of access) or the rear for a neater appearance. In one embodiment, standard ¼″ tubing may be connected to ¾″ irrigation hose for the irrigation tubing. The Adaptive Growing Modules allows for several of water delivery choices, i.e., sprayers, drips, etc. Additionally, a computer system may be set to deliver the correct amount of water for the crop being grown through the irrigation system, this allows for the optimizing of water usage while never over or under watering.

The irrigation tubing tubing may be connected to a submersible pump that sits in a water reservoir. The water reservoir may comprise one or more 26-gallon tanks. The pump may sit on the floor of the growing module and pushes water through a cartridge filter into the irrigation tubing. Additionally, the water reservoir may have a float valve that allows outside water to fill the tank when it is low.

As illustrated in FIGS. 1, 2, and 4; the box (22) may comprise a bottom that slants downward toward, possibly in a slight V shape that causes water to collect in a bottom side water irrigation channel (40) that may be raised in the middle, allowing excess water to be diverted into drainage holes (42) at either end of the box. Water that is drained from the central channel (40) through the drainage holes (42) may be recollected back into a water reservoir.

This design uses significantly less water than a traditional garden. There is no rototilling required, very little physical effort and it makes weeding a breeze.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

What is claimed is:

1. An adaptive growing module, comprising:
a box, said box comprising a bottom, a left side, a right side, a front side, and a back side;
two handles;
legs;
an irrigation hose channel located at the top of the front or back side;
a bottom side water irrigation channel, wherein said bottom side slants down into said bottom side water irrigation channel; and
one or more drainage holes located where said bottom side water irrigation channel meet a side wall.

2. The adaptive growing module of claim 1, wherein said bottom side water irrigation channel is raised in the middle.

3. The adaptive growing module of claim 1, wherein said bottom side slants downward into said water irrigation channel from two opposing sides in a slight V shape.

4. The adaptive growing module of claim 1, further comprising irrigation hose channels on the top of both the front and the back sides.

5. The adaptive growing module of claim 1, wherein said boxes further comprise a box-to-box coupling attachment.

6. The adaptive growing module of claim 1, further comprising: hinges on said legs that allow them to be attached together and fold as a unit, wherein said unit fits inside said box.

7. The adaptive growing module of claim 1, wherein said legs also have points of attachment on their tops or bottoms.

8. The adaptive growing module of claim 1, wherein said box is between 28 and 40 inches long from the left side to the right side.

9. The adaptive growing module of claim 8, wherein said box is 34 inches long from the left side to the right side.

10. The adaptive growing module of claim 1, wherein said box is between 7 and 14 inches tall from the bottom side to the top edges of the front, back, left, and right sides.

11. The adaptive growing module of claim 10, wherein said box is 11 inches tall from the bottom side to the top edges of the front, back, left, and right sides.

12. The adaptive growing module of claim 1, wherein said box is between 19 and 25 inches wide from the front side to the back side.

13. The adaptive growing module of claim 12, wherein said box is 22 inches wide from the front side to the back side.

14. The adaptive growing module of claim 1, wherein said box is built with left, right, front, and back sides that slant outward from the bottom of the box, allowing said box to be nested one inside a similarly shaped box.

15. The adaptive growing module of claim 1, wherein said handles are recesses along the sides of the bottom of said box.
